(19) United States
(12) Patent Application Publication
(10) Pub. No.: US 2014/0113265 A1
(43) Pub. Date: Apr. 24, 2014

(54) PERSONAL ELECTRONIC LEARNING DEVICE

(71) Applicant: Patrick Mantout, Paris (FR)

(72) Inventor: Patrick Mantout, Paris (FR)

(73) Assignee: EDUNOVO, Paris (FR)

(21) Appl. No.: 14/124,417

(22) PCT Filed: Jun. 7, 2012
(86) PCT No.: PCT/FR2012/000228

§ 371 Date: Dec. 6, 2013

(30) Foreign Application Priority Data
Jun. 8, 2011 (FR) 11/01752

(51) Int. Cl. G09B 7/06

(52) U.S. Cl. CPC G09B 7/06
USPC 434/323

(57) ABSTRACT

The personal electronic learning device includes a controller (24) suitable for controlling a motor for displaying a graphical interface in accordance with exercise data and interaction data input by the user via an input interface. The exercise data includes: a plurality of sets of context element data, including, for each set, display data and value data; a set of learning data, including question data, test data, and validation data. The input interface (10) enables the user to enter interaction data in order to move a context element or to modify the value data of a context element.

The invention relates to personal electronic learning devices.

Computing now plays a full part in all areas of modern life, from alarm clocks controlled via the internet through electronic cook books to cars equipped with digital jukeboxes, not forgetting its omnipresence in our professional lives.

This omnipresence has also been extended to learning sectors, either in a professional or in an educational context. There is now the possibility of computer-based learning for languages or for other fields, suitable for a young or a more mature public.

Computer-based learning software is at present based on two main formats.

The first format is a very immersive format in which a universe is created around the envisaged learning, and the final software is almost equivalent to a modern video game in terms of complexity, which, moreover, earns such software the name “serious games”.

This type of software, although very effective, has the disadvantage that it is very complex to implement, has little portability between platforms and is not very reproducible. In fact, it is necessary to start from scratch each time a new software is created. And even the changing of a few simple characteristics within software that has already been programmed can present serious problems.

The second format is a very simplistic format in which learning amounts to a simple page, often of the web page type, which contains a multiple choice questionnaire (MCQ). Such software is in fact “simplistic games”.

This type of software is not satisfactory because it does not offer any interactivity with the user. Moreover, such software is often very poor in terms of graphics, which limits the immersion of the user very considerably. Finally, because it is limited to MCQs, it is not possible to provide exercises that have a sufficient diversity of activity or are adapted to all types of learning.

The invention will improve the situation.

To that end, the invention proposes a personal electronic learning device comprising a controller capable of controlling an engine for displaying a graphical interface as a function of exercise data and as a function of interaction data entered by the user via an input interface.

The exercise data include a plurality of sets of context element data including, for each set, presentation data and value data, and a set of learning data including question data, test data and validation data.

The input interface allows the user to modify the value data of a context element and/or to associate two or more context elements with one another, as interaction data.

The controller is configured to select current question data and, in response to interaction data designating at least one given context element, is further configured to:
control the engine in order to modify the graphical interface as a function of the presentation data of the given context element in order to represent the interaction designated by the interaction data,
execute a test function, said test function comprising:
   determination that the value data associated with the given context element satisfy the validation data, as a function of the current question data and the test data,
   emission of an audible and/or graphical message as a function of that determination, and the selective updating of the current question data, and
   finishing of the exercise as a function of the current question data.

This device is very advantageous because it enables high-quality learning to be offered, in the manner of serious games, while offering the flexibility of programming of simplistic games.

Other features and advantages of the invention will appear non-readily upon reading the following description, which refers to examples given by way of illustration and without implying any limitation, and to the drawings, in which:

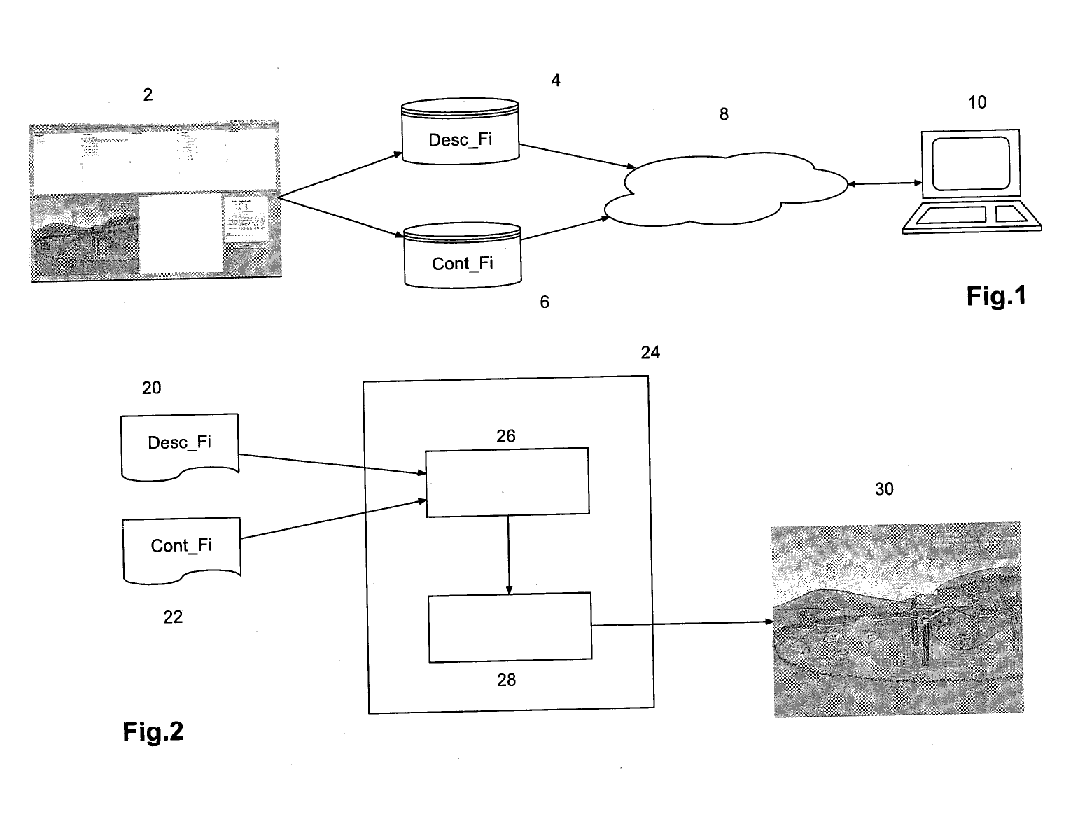

FIG. 1 shows an example of a computer environment using the invention,

FIG. 2 shows a diagram of the implementation of learning software according to the invention,

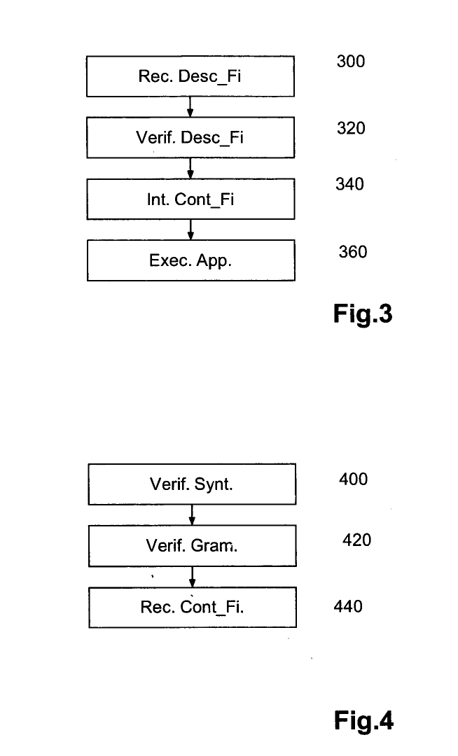

FIG. 3 shows a function chart showing the functioning of a device of FIG. 2,

FIG. 4 shows a function chart of an operation of FIG. 3, and

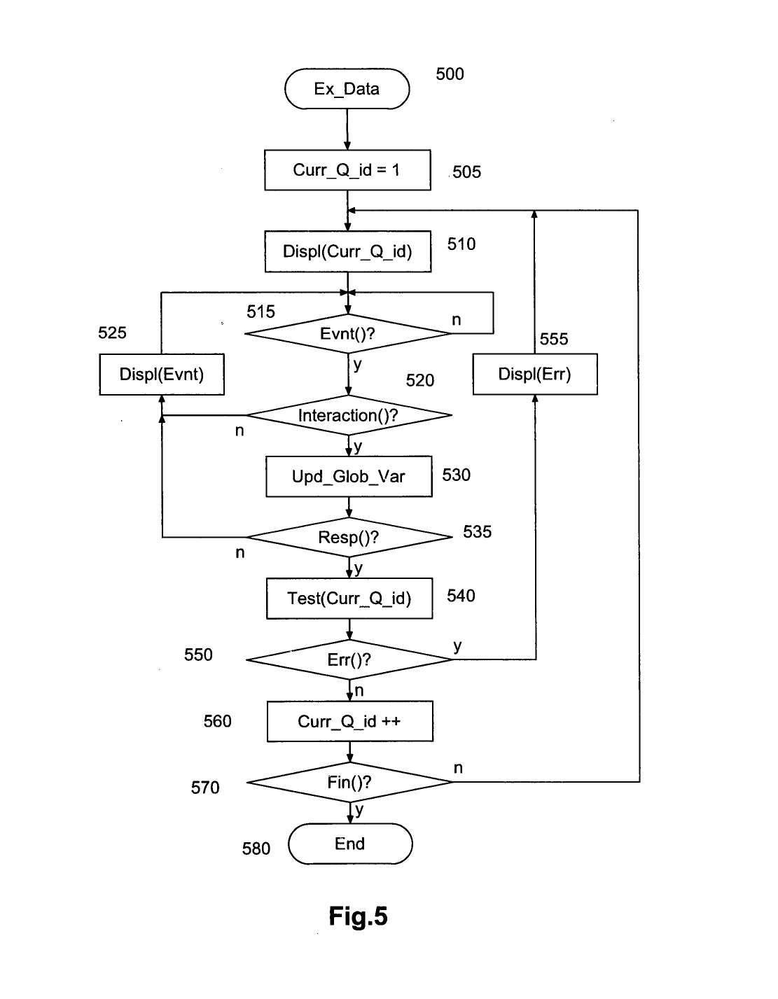

FIG. 5 shows a function chart of another operation of FIG. 2.

The drawings and the description below contain, for the most part, elements of a certain nature. They may therefore not only serve for better understanding of the present invention, but also contribute to the definition thereof, where appropriate.

The nature of the present description is such that it includes elements which are liable to protection by royalties and/or copyright. The holder of the rights has no objection to the identical reproduction by anyone of the present patent document or of its description, as it appears in the official files. For the rest, he reserves his rights wholly.

The field of electronic learning devices is a particular field.

On the one hand, extensive immersion and a specific ambiance are desirable for improving learning, in the manner of video games. This means that the content and the interaction must be quite rich.

On the other hand, easy reproduction is desirable, because many varied exercises are required to achieve effective learning. This means, therefore, that it is important not to start from scratch everytime.

This may appear contradictory. Moreover, that is the principle on which learning software has been created to date: some (“serious games”) favours immersion and interaction to the detriment of reproducibility, while the other (“simplistic games”) favours reproducibility to the detriment of immersion and interaction.

In reality, however, neither of these two approaches is good. The system shown in FIG. 1 will provide a solution which shows that the needs specific to learning software are not contradictory.

The computer environment shown in FIG. 1 comprises a creation station 2, a descriptive file storage space 4, a content storage space 6, a network 8 and a computer station 10.

The creation station 2 allows a creator to design one or more learning programs according to the teaching of the invention.

In a first alternative, the creation station 2 can be a conventional computer which executes a specialised program for creating learning programs. More particularly, the program can include a specific interface adapted to the format of programs of the invention.

Such a program can have the advantage that it is easy to use, offers a direct visual rendering of the learning program that is created, and includes functions for automatically verifying certain rules relating to the format and language of the device of the invention.

In a second alternative, the creation station 2 can be a conventional computer equipped with a simple word processing program, on the basis of which the creator will directly write the description of the exercise or exercises and carry out the associations of content corresponding thereto.

The function of the storage spaces 4 and 6 is to store the computer elements which will define in abstract terms the learning programs and the exercises that they contain.

Accordingly, the storage space 4 receives files which will be referred to hereinbelow by the term “Des_Fi”. These files are text files and contain a description of each exercise. This description will be explained below in the following and includes a simplified graphical description of the exercise, as well as the definition of all the sound, visual and educational interactions of the exercise.

According to a first alternative, a given file of the storage space 4 corresponds to a single exercise, which can subsequently be called up independently by any program that has access to the storage space 4.

According to a second alternative, each file of the storage space 4 corresponds to a learning program and can therefore include a plurality of exercises which can be called up when the program is executed.

The storage space 6 in turn receives all the content data which are associated with the files of the storage space 4. More precisely, it has been explained that each file of the storage space 4 includes a text description of an exercise. This description contains references to image and/or sound and/or video files. It is those files that are stored in the storage space 6.

The storage spaces 4 and 6 can be made in many ways. Thus, the storage spaces can be located on a hard disk or any other storage medium of the creation station 2 or on any storage space that is accessible from the creation station 2, such as a remotely hosted storage space accessible via the internet or by other means.

A distinction is made here between the storage spaces 4 and 6 in order to highlight the difference between the files that they receive. However, these spaces can also be created within the same directory of a given storage medium or within a plurality of distinct directories of the storage medium. They can also be distributed over a plurality of distinct storage media.

Once the exercise has been created, it is wholly described by the file which corresponds to it in the storage space 4 and by the corresponding content files in the storage space 6. In an alternative, the files of the storage space 4 and the file of the storage space 6 can be encapsulated in an exercise data container.

The storage spaces 4 and 6 are made accessible by a network 8 to the station 10. The network 8 can be a local network or any type of extended network, including the internet. In another alternative, the storage spaces 4 and 6 can be reproduced on a storage medium such as a hard disk, a CD-ROM or a DVD executed at the station 10.

The computer station 10 can be any known type of computer station. The only constraint is that the station must be capable of executing the program of the invention and capable of accessing the storage spaces 4 and 6.

More precisely, the invention can be set up via the internet, that is to say a user of the station 10 will visit a web site. The web site includes a program which will interpret the files of the storage spaces 4 and 6 and restore them to the station 10 in the form of a web page.

In an alternative, the invention can be put on a storage medium as specified above, and the program that interprets and restores the files of the storage spaces 4 and 6 is stored with them on the medium. It is then necessary for the station 10 to be capable of executing the program, from the point of view of both compatibility of the operating system and computing capacity.

Finally, these two alternatives can be combined, that is to say some files can be accessible via the internet or another extended network while others are present on a physical medium. This applies both to the files of the storage spaces 4 and 6 and to the program for interpreting and restoring them.

FIG. 2 shows an example of the functioning of the invention at the station 10. In this example, the computer station 10 is a personal electronic learning device.

The personal electronic learning device 10 receives a file 20 from the storage space 4 and a file 22 from the storage space 6. The files 20 and 22 correspond to a chosen exercise. File 20 includes the exercise data which describe it, and file 22 includes the content data of the exercise.

The files 20 and 22 are transmitted to a controller 24 of the personal electronic learning device 10. The controller 24 comprises a weaver 26 and an engine 28.

The function of the weaver 26 is to generate an exercise 30 ready to be displayed by the engine 28, under the control of the controller 24.

FIG. 3 shows a function chart of the functioning of the device of the invention.

As can be seen in this figure, the controller 24 receives the file 20 in an operation 300. In this example, this operation takes place at the station 10. In other embodiments, this step may be carried out remotely, on a server.

Then, in an operation 320, the weaver 26 verifies the contents of the file 20. The device 10 is in fact based on the use of an exercise description file which obeys a particular syntax, which allows the maximum amount of information to be included in the minimum amount of space.

In the example described here, the file 20 is written in XML, according to a syntax and a grammar proper to the invention. However, any other programming language of hierarchical format can be suitable for carrying out the invention.

FIG. 4 shows an example of the execution of operation 320. Verification of the file 20 begins with an operation 400 of verification of the syntax of the file. To that end, the weaver 26 verifies the XML syntax of the file 20.

This is important because, although a program for automatic generation of exercise description files is provided, it is also possible to write them by hand.

In the example described here, the exercise description file includes a plurality of distinct parts forming exercise data.

A first part comprises parameter declarations, such as the functional type of exercise (card-based, number-based, letter-based, button-based, with or without deferred correction, etc.) and instructions on the type of learning (of the type “collect the even cards”, “calculate the sum of the cards”, etc.) forming exercise data.

A second part comprises the description of the context elements of the exercise, such as the setting, the interaction elements, the different planes, etc.

For the interaction elements, which can therefore be moved and/or modified, this second part will specify their identifier, their starting position, as well as their nature. In a card-based exercise, for example, some elements are cards to be moved from one location to another.

A starting block is therefore defined, in which a plurality of zones which each contain an interaction element are defined. A destination block is likewise defined, in which a plurality of destination zones are defined, for carrying out the exercise. Sounds can be associated with each interaction element in order to increase the immersion of the user.

A third part comprises a truth table which contains the response to the exercise and which forms validation data. The third part also comprises validation tests of the responses to the questions of the exercise forming test data, and messages for the user as a function of his responses. The functioning of these elements will be described below with FIG. 5. The third part constitutes the “dynamic” part of the description of the exercise.

Finally, a fourth part comprises graphical, and optionally sound, data declarations allowing access to the contents declared above in the other second and third parts.

Once the syntax of the file 20 has been verified, the operation 320 continues with an operation 420 in which the grammar of the file 20 is verified. More precisely, this operation verifies that the file 20 is described in accordance with the four-part structure described above, and that the structure is coherent.

When there are simple problems of syntax and/or grammar, the weaver 26 can correct them on the fly in order to allow execution that is as rapid as possible for the user. In an alternative, or when the error cannot be corrected directly by the weaver 26, a message is emitted to indicate to the user that the exercise cannot be executed.

When operations 400 and 420 are completed successfully, the file 22 is called up in an operation 440 in order to allow the content data contained therein to be merged with those of the file 20.

This is carried out in an operation 340, with merging of the file 22, which contains the declared content data, with the file 20 to form an executable exercise.

Depending on the embodiments, the executable exercise may or may not be obfuscated, contained in a Flash file or in another plugin of multimedia content, or can be carried out in the form of a web page of type AJAX, aspx, php, jsp or the like.

Finally, the program is executed in an operation 360 until the end of the exercise is determined.

FIG. 5 shows an example of the implementation of operation 360. This implementation begins at 500 with the receipt of the exercise data as merged in operation 340.

These data correspond to the totality of the global parameters of the exercise, as well as the declaration of each of the interaction objects and of the questions of the exercise, with their corresponding identifiers.

In an operation 505, a variable Curr_Q_id receives the index of the first question of the exercise. The controller 24 then launches an exercise execution loop.

This loop begins in an operation 510 with a function Displ( ), which displays the information relating to the current question of the exercise. An exercise can in fact comprise a plurality of questions. Progression in each exercise is conditional upon obtaining a correct response to each current question, until there are no further questions.

The information relating to the current question includes, when necessary, resetting the setting and the interaction elements of the exercise, as is described for each question in the second part of file 20. This resetting can be omitted when the questions are intended to be linked.

That is the case, for example, when a first question requires all the even cards to be collected and the second question requires, for example, all the cards that are multiples of three to be collected: it is not necessary to put all the cards back in their starting positions, and the end position of one question can thus serve as the starting position for a following question.

A sub-loop 515 of event detection is then launched, in which the controller 24 waits for an action entered by a user input interface to be performed. An example of such an action is the action of “dragging and dropping” a card to a given position. As long as this operation 515 does not detect an action, nothing happens.

When an action is detected, a test is carried out in an operation 520 to determine whether this action is a simple interaction operation, of the type click on an element of the setting, a help button, or an operation of moving an interaction element, or whether this action constitutes a response to a question, which must therefore be verified.

In the first case, it is a question of modifying the graphical interface of the exercise and/or emitting a sound or another response to the user in response to the interaction. This is carried out by the function Displ( ) in an operation 525.

In the second case, a function Upd_Glob_Var( ) is launched in an operation 530. The exercises of the invention are intended to be executed in application environments intended mainly for display and presentation, such as Flash or another environment of this type.

Under these conditions, the programming possibilities are limited and it is not possible to maintain global variables in a simple manner. A global variable is understood as being any information that is used for the exercise, such as the number of cards in a destination zone, the sum of the values of the cards placed in a destination zone, etc.

This problem is avoided by recalculating at each interaction a chosen quantity of values. Accordingly, the fact of calculating values corresponding to the global variables at each detected interaction allows the absence of global variables, strictly speaking, to be compensated for.

The values to be calculated at each interaction are defined by the exercise data. Accordingly, each exercise belongs to a type family, with which there is associated a group of variables to be calculated at each interaction.

The possible types of exercises include:
card-based exercises with immediate or deferred correction,
button-based exercises with immediate or deferred correction,
colouring exercises with immediate or deferred correction, and
text-zone-based exercises with immediate or deferred correction.

For card-based exercises with immediate or deferred correction, the global variables which are calculated at each interaction include:
a table of the card identifiers as a function of the position of each card,
a table of the values of the cards as a function of the position of each card,
a sum of the values of the cards as a function of their position,
etc.

For button-based exercises with immediate or deferred correction, the global variables which are calculated at each interaction include:
a table of the values of the displayed buttons, classified by increasing identifier,
a table of the activation state of the displayed buttons, classified by increasing identifier,
a number of activated/modified buttons,
etc.

For text-zone-based exercises, the global variables which are calculated at each interaction include:
a table of the character chains displayed in each text zone,
a number of a text zone that is not empty,
a current character,
etc.

Once these variables have been updated, a function Resp( ) determines, in an operation 535, whether the detected interaction involves a response to a question or not.

The detected interaction can be of several types. However, whatever the interaction, the interaction data have the effect of modifying the value data of a given element.

The interaction can consist in changing the value of a card, or the state of a button, or in entering a text chain. It is then clearly apparent that it is a question of changing the value data of a given element, that is to say the card, the text chain or the button. When the interaction consists in associating a card with a given zone, the situation is no different: it is the value data of the zone that are modified, in order to receive an identifier of the card in question.

If the detected interaction does not involve a response, it is an exercise with deferred correction. It is therefore simply a question of displaying the interaction, via operation 525. Depending on the exercise, the operation can include the verification of certain conditions as a function of the exercise. For example, if the exercise is with deferred correction and the question is to collect cards on which vowels are written, operation 525 can emit a message when a consonant is selected, in order to help the user.

In the case of an exercise with immediate correction, any interaction constitutes a response and is evaluated instantaneously. For example, in the screen shown in FIG. 1, the question is “Put all the fish bearing even numbers in the net”. This exercise is a card-type exercise with immediate correction, for which each card deposited in a net is verified as to whether it is in the correct location. In the case of an exercise with deferred correction, the detection of a response is triggered by pressing a specific button, indicating that the user has finished.

A function Test( ) is then launched in an operation 540 to correct the response. As a function of the variable Curr_Q_id, the function Test( ) will analyse whether the response formulated by the user is correct. To that end, the function Test( ) will carry out one or more tests which are described in the third part of the file 20 and designated by the variable Curr_Q_id. These tests can be based on the values of some of the interaction elements or on value data designating the mutual association of two interaction elements.

Here too, since the environment is mainly graphical, the function Test( ) will first systematically analyse the formulae of the tests designated by the variable Curr_Q_id in order to transcribe them in a code which can be analysed in the execution environment.

Then, on the basis of the global variables updated in operation 530 and the retranscribed tests, the function Test( ) determines whether the response or responses is/are correct.

In practice, various tests can be carried out as a function of the exercise:
for a question which consists in calculating the sum of cards and writing it in a result card, it is the data of the value of that card which will be tested;
for a question in which the even cards must be collected in a particular zone, it is the value data indicating the card-zone association which will be tested;
for a question in which a particular text must be written in a text zone, it is the text data which will be tested;
for a question in which certain buttons must be activated as a function of their value, it is the states of the buttons which will be tested,
etc.

Typically, the function Test( ) will include a larger number of tests for an exercise with deferred correction than for an exercise with immediate correction. In an exercise with immediate correction, a single response is tested with each interaction, whereas in an exercise with deferred correction, the function Test( ) corrects all the responses.

At the output of the function Test( ) a value indicates whether the response is correct or incorrect. This value is tested in an operation 540. If there has been an error, the function Displ( ) is called up to display a corresponding message in an operation 555, and the loop resumes at 510. In an alternative, the operation 555 can reinitialise the graphical interface completely or simply indicate the error.

If the response is correct, the variable Curr_Q_id is incremented in an operation 560. This allows the user to move on to the following question of the exercise. A test is then carried out by a function Fin( ) in an operation 560 to determine whether the exercise is finished.

This test can consist, for example, in analysing whether the variable Curr_Q_id corresponds to a question index or not, or looking at the number of responses (and therefore questions) in the truth table.

If a question remains, the loop resumes at 510 with the display of the data relating to that question, and a response is awaited.

Otherwise, the exercise finishes at 570, with the optional emission of a message of congratulation to the user.

1. Personal electronic learning device, comprising a controller (24) capable of controlling an engine for displaying a graphical interface as a function of exercise data and as a function of interaction data entered by the user via an input interface,
characterised in that the exercise data include:
a plurality of sets of context element data including, for each set, presentation data and value data,
a set of learning data including question data, test data and validation data,
the input interface (10) allowing the user to enter interaction data in order to move a context element or in order to modify the value data of a context element,
the controller (24) being configured to select current question data and, in response to interaction data designating at least one given context element, further being configured to:
control the engine in order to modify the graphical interface as a function of the presentation data of the given context element in order to represent the interaction designated by the interaction data,
calculate global variable data as a function of the interaction data, value data of the context elements, and question data;
selectively execute a test function, said test function comprising:
the selection of the test data and of the validation data designated by the current question data,
determination that the value data associated with the given context element satisfy the selected validation data, as a function of the calculated global variable data and the selected test data,
emission of an audible and/or graphical message as a function of that determination, and the selective updating of the current question data, and
finishing of the exercise as a function of the current question data.

2. Device according to claim 1, wherein the controller (24) is configured to execute the test function when the interaction data indicate a response.

3. Device according to claim 2, wherein the controller (24) is configured to determine whether the interaction data indicate a response as a function of the question data.

4. Device according to claim 1, wherein the controller (24) is configured to display an error message when the test function determines that the value data associated with the given context element do not satisfy the determined validation data, as a function of the calculated global variable data and the determined test data.

5. Device according to claim 1, wherein the context elements are chosen from the group comprising a card, a button, a text zone and a card deposit zone.

6. Device according to claim 1, wherein the question data include a text and/or audible indication of the question.

7. Device according to claim 1, wherein the presentation data include graphical data.

8. Device according to claim 7, wherein the presentation data include audible data.

9. Device according to claim 2, wherein the context elements are chosen from the group comprising a card, a button, a text zone and a card deposit zone.

10. Device according to claim 2, wherein the question data include a text and/or audible indication of the question.

11. Device according to claim 2, wherein the presentation data include graphical data.

12. Device according to claim 3, wherein the controller (24) is configured to display an error message when the test function determines that the value data associated with the given context element do not satisfy the determined validation data, as a function of the calculated global variable data and the determined test data.
